(19) United States
(12) Patent Application Publication
(10) Pub. No.: US 2008/0239634 A1
(43) Pub. Date: Oct. 2, 2008

(54) Flat Panel Display Device

(76) Inventors: Taketoshi Nakao, Kyoto (JP); Kiyohide Amemiya, Kanagawa (JP); Hiroaki Takezawa, Nara (JP); Hiroto Yanagawa, Osaka (JP); Tetsuo Kawakita, Kyoto (JP)

Correspondence Address: MCDERMOTT WILL & EMERY LLP, 600 13TH STREET, NW, WASHINGTON, DC, 20005-3096, US

(21) Appl. No.: 10/590,908

(22) PCT Filed: Feb. 15, 2006
(86) PCT No.: PCT/JP2006/002608

§ 371 Date: Aug. 28, 2006

(30) Foreign Application Priority Data
Feb. 28, 2005 (JP) 2005-053318

(51) Int. Cl. G06F 1/16

(52) U.S. Cl. 361/681

(57) ABSTRACT

A flat panel display device is provided which is capable of reliably inhibiting the surface temperature of a relevant portion of the casing of the flat panel display device from rising too much while efficiently cooling the inside of the casing. The flat panel display device (100) of the invention includes: a flat display panel (11); a front cover (15) having an opening matching a display surface of the flat display panel (11); and a casing (18) having a first casing section (20) and a second casing section (21) and covering a rear side of the flat display panel (11), the first casing section (20) having a lower thermal conductivity than the second casing section (21), extending upwardly from the second casing section (21), and being provided with a vent hole.

### RELATED APPLICATION

This application is a national phase of PCT/JP2006/302608 filed on Feb. 15, 2006, which claims priority from Japanese Application No. 2005-053318 filed on Feb. 28, 2005, the disclosures of which Applications are incorporated by reference herein. The benefit of the filing and priority dates of the International and Japanese Applications is respectfully requested.

### TECHNICAL FIELD

The present invention relates to flat panel display devices and, more particularly, to a flat panel display device capable of inhibiting the surface temperature of a flat panel display casing and the temperature within the casing from rising too much.

### BACKGROUND ART

Plasma display panels (hereinafter will be referred to as PDPs) have become widespread as display devices of which representatives are thin-screen televisions.

PDPs are display devices capable of realizing a thin and large screen display. In recent years, the volume of production of PDPs has been increasing by leaps and bounds like liquid crystal display panels.

A large number of technical literature documents have already been published concerning the display technology of such plasma display devices (see non-patent document 1 for example).

FIG. 13 shows one exemplary construction of an existing plasma display device using a PDP as a display device; specifically, FIG. 13(a) is a rear view showing the plasma display device as viewed from behind and FIG. 13(b) is a sectional view, taken along line B-B of FIG. 13(a), of the plasma display device.

As shown in FIG. 13, a rectangular PDP 111 has a rear side joined with and fixed to a rectangular metal support plate 112 having a slightly larger area than the PDP 111. The metal support plate 112 holding the PDP 111 is secured to a leg portion 113.

A front plate 115, which is positioned on the front side of the PDP 111, has an opening matching a display surface (not shown) of the PDP 111. An optical filter 114 is mounted on the front plate 115 so as to fit in the opening.

The front plate 115 thus fitted with the optical filter 114 serves to shield electromagnetic waves, adjust a chromatic purity and protect the PDP 111 against external shock.

On the rear side of the metal support plate 112, a circuit board 117 carrying various electronic components 116 (including a driver LSI for example) mounted thereon for driving the PDP 111 is fixed to the metal support plate 112 as spaced a fixed clearance from the rear surface of the metal support plate 112 by means of a spacer S.

A casing 110, which functions as a back cover embracing the PDP 111, metal support plate 112, electronic components 116 and circuit board 117 from behind, is mounted on the leg portion 113. The front plate 115 is fitted on a front portion of this casing 110.

The casing 110 is provided with plural mesh vent holes 119a, 119b and 119c as air exhaust or intake vents at suitable portions thereof.

As compared with other displays such as a liquid crystal display panel and a cathode-ray tube, the PDP 111 is likely to be heated to elevated temperatures due to image display relying upon discharge light emission. Since the PDP 111 uses a higher driving voltage than the other displays (driving voltage: 200 to 300 V), the electronic components 116 (including the driver LSI for example) can also be heated to elevated temperatures. Further, there is a tendency to raise the driving voltage of the driver LSI in order to raise the luminous efficiency of the PDP 111. This tendency is considered to make the thermal problem of the plasma display device 160 more noticeable.

In attempt to minimize elevation in the temperature within the casing of the plasma display device 160 due to long-time display of the PDP 111, various heat dissipation techniques for the plasma display device 160 have hitherto been developed.

For example, a plasma display device has been disclosed which is intended to efficiently suppress localized heat generation by the PDP, wherein: a heat-conductive sheet comprising silicone rubber or the like is interposed between the PDP and a heat conduction plate of aluminum in order to improve the heat transfer coefficient between the PDP and the heat conduction plate thereby enhancing the thermal contact therebetween; and plural heat pipes, heat dissipation fins and a heat dissipation fan are disposed above the heat conduction plate (see patent document 1).

Also, a cooling structure for plasma displays has been disclosed wherein a radiator joined with a PDP supporting chassis and with an electronic component is connected to a rear cover having a high thermal conductivity comprising an aluminum plate for example, thereby making it possible to dissipate heat generated from the PDP and the electronic component through the rear cover efficiently (see patent document 2).

Further, a PDP rear frame which has its weight kept light and is excellent in strength and heat dissipation property has been obtained by forming a linear ridge-groove structure on an internal surface of the PDP rear frame having an excellent thermal conductivity (comprising an aluminum plate for example) (see Patent document 3).

Non-patent document 1: FLAT PANEL DISPLAY 1999 (NIKKEI MICRODEVICES)
Patent document 1: Japanese Patent Laid-Open Publication No. HEI 11-251777
Patent document 2: Japanese Patent Laid-Open Publication No. 2000-347578
Patent document 3: Japanese Patent Laid-Open Publication No. 2001-242792

### DISCLOSURE OF INVENTION

### Problem to be solved by Invention

As can be understood from the heat dissipation techniques for PDPS described in the aforementioned patent documents 1 to 3, a metal plate or casing comprising a material having an excellent thermal conductivity has heretofore been used to dissipate heat generated from the PDP and from the electronic component (driver LSI) to the outside.

By bringing the aforementioned heat generating members such as the PDP and the electronic component into direct or indirect contact with the metal plate or casing having a high thermal conductivity, it becomes possible to allow heat generated within the casing or the like to be transferred to the entire surface of the casing or the like quickly thereby to allow the heat generated within the casing to be efficiently dissipated into the atmosphere through the casing or the like, thus inhibiting the temperature within the plasma display device from rising too much.

However, the use of such a casing having a high thermal conductivity (particularly in an upper portion of the casing which is likely to be touched by a consumer or user) gives rise to such a reflex demerit that the surface (outer surface) temperature of the casing is easy to rise, which may pose thermally-induced uncomfortable feeling or the like for the consumer.

The present invention has been made in view of the foregoing circumstances. Accordingly, it is an object of the present invention to provide a flat panel display device which is capable of reliably inhibiting the surface temperature of a relevant portion of the casing of the flat panel display device from rising too much while efficiently cooling the inside of the casing.

### Means for Solving Problem

The heat dissipation process of a plasma display device is considered to involve heat dissipation caused by natural air convection, heat conduction by the casing or the like, and heat radiation by the casing or the like. The inventors of the present invention had a question of whether or not the existing techniques relying upon a highly thermal-conductive casing or the like made uniform in heat distribution could be highly efficient in any case. As a result of study of this question, the inventors have found a heat dissipation method which is completely different in viewpoint from the conventional heat dissipation methods by making full use of the thermo-fluid simulation technology.

In order to accomplish the aforementioned object, the present invention provides a flat panel display device including: a flat display panel; a front cover having an opening matching a display surface of the flat display panel; and a casing having first and second casing sections and covering a rear side of the flat display panel, the first casing section having a lower thermal conductivity than the second casing section, extending upwardly from the second casing section, and being provided with a vent hole.

In one embodiment, the first casing section is in contact with an end portion of the second casing section.

In another embodiment, the first casing section and the second casing section define a clearance therebetween.

Here, the flat panel display device may have the function of exhausting air through the vent hole.

With such an arrangement, the first casing section having a relatively low thermal conductivity in an upper portion of the casing allows air in the internal space defined by the casing to be effectively displaced by virtue of an increased air flow velocity caused by the ascending force of warmed air in the internal space of the casing and, hence, the flat panel display panel located within the casing can be cooled efficiently.

Also, the ascending force of warmed air in the upper portion of the casing allows air within the casing to be exhausted to the outside effectively, which makes it possible to eliminate the need to provide an exhaust or intake fan additionally.

Further, because the first casing section located in the upper portion of the casing which the consumer is likely to touch is hard to warm, the flat panel display device does not pose thermally-induced uncomfortable feeling or the like for the consumer.

In addition to the aforementioned advantages, if the flat panel display device has the function of taking in air through the aforementioned clearance, smoother venting of air can be realized advantageously.

For example, the first casing section is formed from a material comprising resin, while the second casing section formed from a material comprising metal.

A preferable range of the thermal conductivity of the first casing section is not less than 0.02 J/msK and less than 1.5 J/msK, while a preferable range of the thermal conductivity of the second casing section not more than 2320 J/msK and more than 80 J/msK.

A value obtained by dividing a vertical width of the first casing section by a vertical width of the casing is desirably more than 1/10 and less than 7/10.

The aforementioned ranges are found to be proper in terms of the heat dissipation characteristics of the casing from simulation results obtained by using general-purpose analysis software (STREAM™).

Another embodiment of the first casing section may have an extended portion extending continuously with the second casing section and comprising the same material as the second casing section, and a cover portion layered to cover an outer surface of the extended portion, the cover portion extending upwardly while being in contact with the outer surface of the extended portion.

Yet another embodiment of the first casing section may have a separated portion spaced by a clearance from the second casing section and comprising the same material as the second casing section, and a cover portion layered to cover an outer surface of the separated portion, the cover portion extending upwardly while being in contact with the outer surface of the separated portion.

Even with such an arrangement, the first casing section having a relatively low thermal conductivity (cover portion) in an upper portion of the casing allows air in the internal space defined by the casing to be effectively displaced by virtue of an increased air flow velocity caused by the ascending force of warmed air in the internal space of the casing and, hence, the flat panel display panel located within the casing can be cooled efficiently.

Also, the ascending force of warmed air in the upper portion of the casing allows air within the casing to be exhausted to the outside effectively, which makes it possible to eliminate the need to provide an exhaust or intake fan additionally.

Further, because the first casing section (cover portion) located in the upper portion of the casing which the consumer is likely to touch is hard to warm, the flat panel display device does not pose thermally-induced uncomfortable feeling or the like for the consumer.

An example of a material for the first casing section is resin and an example of a material for the second casing section is metal.

For example, a preferable range of the thermal conductivity of the cover portion is not less than 0.02 J/msK and less than 1.5 J/msK, while a preferable range of the thermal conductivity of the second casing section not more than 2320 J/msK and more than 80 J/msK.

A value obtained by dividing a vertical width of the first casing section by a vertical width of the casing is desirably more than 1/10 and less than 4/10.

The aforementioned ranges are found to be proper in terms of the heat dissipation characteristics of the casing from simulation results obtained by using the general-purpose analysis software (STREAM™).

The aforementioned flat display panel may be a plasma display panel.

The foregoing and other objects, features and attendant advantages of the present invention will become more apparent from the reading of the following detailed description of the preferred embodiments in conjunction with the accompanying drawings.

### ADVANTAGE OF INVENTION

According to the present invention, a flat panel display device is provided which is capable of reliably inhibiting the surface temperature of a relevant portion of the casing section of the flat panel display from rising too much while efficiently cooling the inside of the casing.

### BRIEF DESCRIPTION OF DRAWINGS

FIG. 1 is an illustration showing one exemplary construction of a plasma display device according to embodiment 1 of the present invention.

FIG. 2 is an illustration showing another exemplary construction of the plasma display device according to embodiment 1 of the present invention.

FIG. 3 is an illustration three-dimensionally modeling the plasma display device of FIG. 1 for numerical calculation.

FIG. 4 is a diagram showing one exemplary analysis result obtained by an appropriate processing method based on physical quantity calculation data on each element of the analytical model shown in FIG. 3.

FIG. 5 is a diagram showing another exemplary analysis result obtained by an appropriate processing method based on physical quantity calculation data on each element of the analytical model shown in FIG. 3.

FIG. 6 is a diagram showing another exemplary analysis result obtained by an appropriate processing method based on physical quantity calculation data on each element of the analytical model shown in FIG. 3.

FIG. 7 is an illustration showing one exemplary construction of a plasma display device according to embodiment 2 of the present invention.

FIG. 8 is an illustration showing another exemplary construction of the plasma display device according to embodiment 2 of the present invention.

FIG. 9 is an illustration three-dimensionally modeling the plasma display device of FIG. 7 for numerical calculation.

FIG. 10 is a diagram showing one exemplary analysis result obtained by an appropriate processing method based on physical quantity calculation data on each element of the analytical model shown in FIG. 9.

FIG. 11 is a diagram showing another exemplary analysis result obtained by an appropriate processing method based on physical quantity calculation data on each element of the analytical model shown in FIG. 9.

FIG. 12 is a diagram showing another exemplary analysis result obtained by an appropriate processing method based on physical quantity calculation data on each element of the analytical model shown in FIG. 9.

FIG. 13 is an illustration showing one exemplary construction of an existing plasma display device using a PDP as a display device.

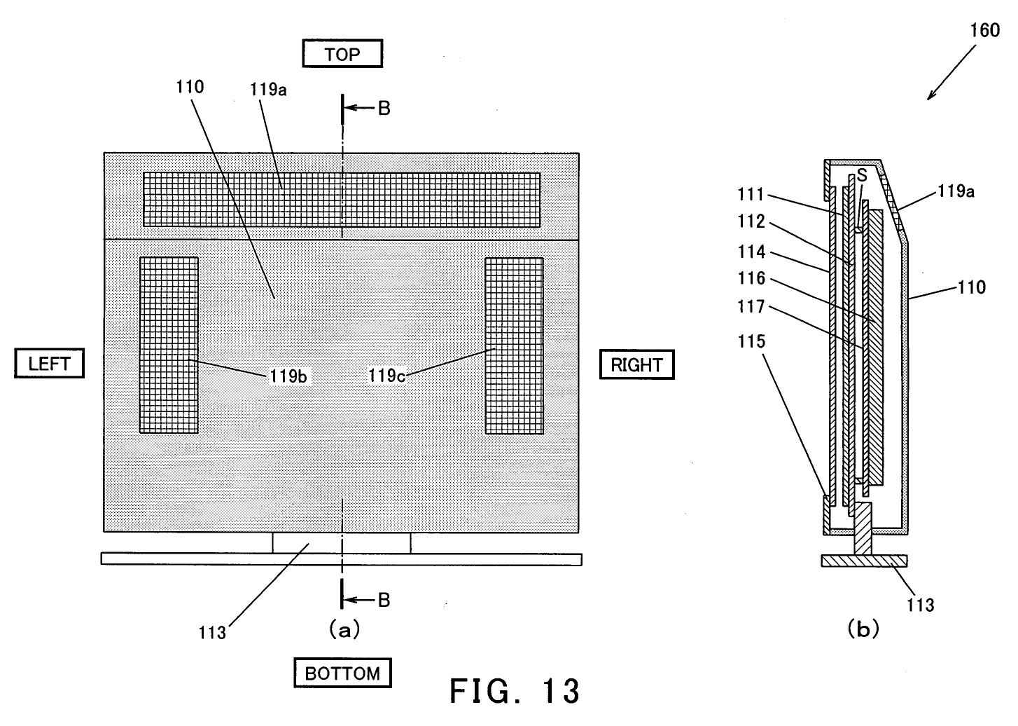

### DESCRIPTION OF REFERENCE CHARACTERS

11 . . . PDP
12 . . . metal support plate
13 . . . leg portion
14 . . . optical filter
15 . . . front plate
16 . . . electronic component
17 . . . circuit board
18 . . . casing
19a,19b,19c . . . vent hole
19d . . . opening
20 . . . first casing section (resin layer)
21a . . . extended portion (separated portion)
21,21b . . . second casing section
22 . . . clearance
100,110,130,140,160 . . . plasma display device
120,150 . . . analytical model

### BEST MODE FOR CARRYING OUT INVENTION

Hereinafter, preferred embodiments 1 and 2 of the present invention will be described with reference to the drawings.

### Embodiment 1

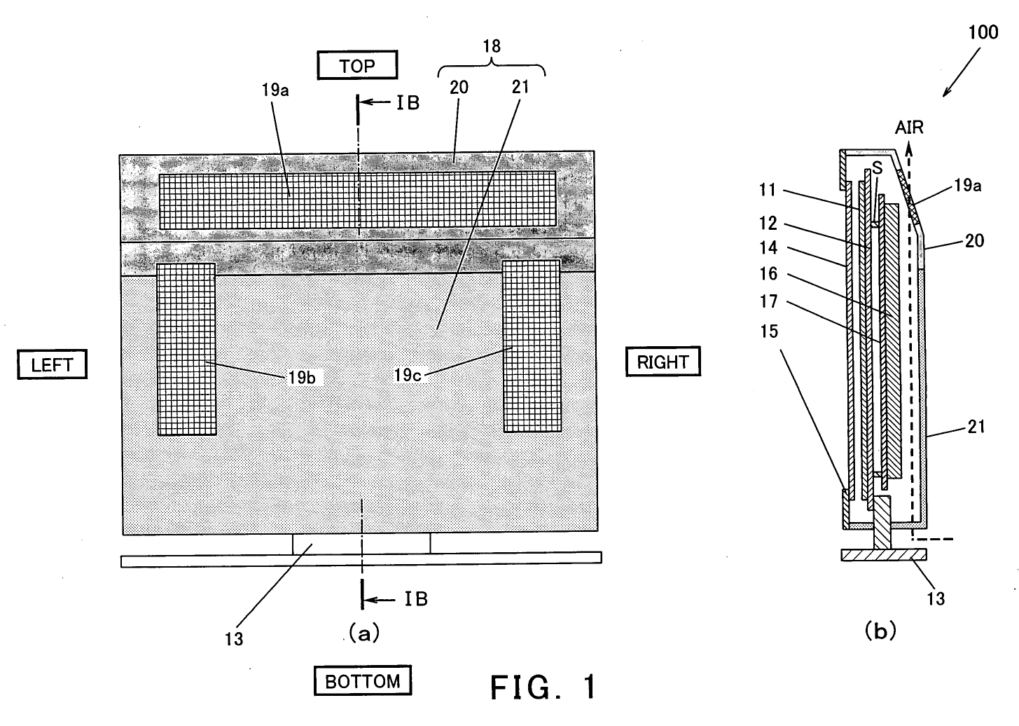

FIG. 1 is an illustration showing one exemplary construction of a plasma display device according to embodiment 1 of the present invention. Specifically, FIG. 1(a) is a rear elevational view showing the plasma display device as viewed from behind and FIG. 1(b) is a sectional view, taken along line IB-IB of FIG. 1(a), of the plasma display device.

According to FIG. 1, a substantially rectangular PDP 11 is joined on the rear side thereof with a substantially rectangular metal support plate 12, which is positioned to hold the PDP 11. The metal support plate 12 is fixed to a leg portion 13 serving as a pedestal of the plasma display device 100.

A front plate 15 (front cover) is positioned on the front side of the PDP 11 so as to be joined with a casing 18 (to be described in detail later) corresponding to a back cover.

The front plate 15 has an opening matching the display surface of the PDP 11. An optical filter 14, which comprises an electromagnetic wave shielding sheet, a color correction film, reinforced glass and the like, is attached to the front plate 15 so as to fit in the opening. Thus, the plasma display device 100 is capable of electromagnetic wave shielding, chromatic purity adjustment and external shock protection.

On the rear side of the metal support plate 12, a circuit board 17 carrying an electronic component 16 (for example a driver LSI) mounted thereon for driving the PDP 11 is fixed in position to the metal support plate 12 via an appropriate spacer S.

The casing 18 is positioned to embrace the PDP 11, metal support plate 12 and circuit board 17 from behind. The casing 18 together with the front plate 15 functions as a designed casing of the plasma display device 100.

The casing 18 is mounted on the leg portion 13 and joined with the front plate 15 by appropriate fastening means (such as adhesive, mechanical fit or the like).

The structure of the casing 18 will be described in detail with reference to the drawings.

The casing 18 comprises plural materials that are different in thermal conductivity from each other. In one example, the casing 18 is divided into two sections at an appropriate position along vertical direction (on the vertical axis of the plasma display device 100). (Such an appropriate dividing position is calculated by thermo-fluid simulation, as will be described later.) A first casing section 20 comprising a resin material having a relatively low thermal conductivity or the like is in contact with and extends upwardly from the aforementioned dividing position coinciding with an end portion of a second casing section 21 comprising a metal material having a relatively high thermal conductivity or the like. The first casing section 20 and the second casing section 21 are joined with each other by appropriate fastening means (such as adhesive, mechanical fitting or the like). As can be easily understood from the supposition that the first and second casing sections 20 and 21 are mechanically fitted with each other, the term “end portion” of the second casing section 21, as used here, is meant to include not only the topmost end face of the second casing section 21 shown in FIG. 1 but also edge portions adjacent the end face (exactly speaking, side surfaces adjacent the end face of the second casing section 21) that are necessary for mechanical fitting. Therefore, it is possible to fit edge portions of respective of the first and second casing sections 20 and 21 with each other and fasten the two together.

In this embodiment, the first casing section 20 (in an upper portion of the plasma display device 100) is provided with a substantially rectangular vent hole 19a extending in the horizontal direction of the plasma display device 100 as an air exhaust hole in the form of mesh for exhausting air from the inside of the casing 18.

The second casing section 21 has a lower end face provided with an appropriate vent hole (not shown) as an air intake hole for taking air into the casing 18.

Thus, air taken into the casing 18 through the vent hole located at the lower end face of the second casing section 21 is warmed within the casing 18 and then exhausted to the exterior of the casing 18 through the vent hole 19a along a path depicted by dotted line in FIG. 1(b) according to the principle of ascending force of air (to be described later).

The second casing section 21 has opposite lateral side portions provided with a pair of substantially rectangular vent holes 19b and 19c extending vertically of the plasma display device 100 as air intake holes for taking air into the casing 18, the pair of vent holes 19b and 19c being positioned to face a pair of driver LSIs mounted on the circuit board 17. These vent holes 19b and 19c also allow fresh outside air to flow into the casing 10 therethrough.

Examples of materials for the first casing section 20 include a resin comprising polyethylene as a major component (thermal conductivity: 0.25 to 0.34 J/msK), a resin comprising glass fiber as a major component (0.24 to 1.21 J/msK), a resin comprising bakelite as a major component (0.21 J/msK), a resin comprising epoxy-glass as a major component (0.47 J/msK), and foamed polyurethane (0.02 J/msK). In brief, it is desirable that a member having a thermal conductivity of less than 1.5 J/msK be used as the component of the first casing section 20. A preferable range of the thermal conductivity of the first casing section 20 is not less than 0.02 J/msK and less than 1.5 J/msK for example.

Examples of materials for the second casing section 21 include aluminum (thermal conductivity: 237 J/msK), iron (80.4 J/msK), copper (401 J/msK), magnesium (156 J/msK), silver (429 J/msK), graphite (1960 J/msK), and diamond (1360 to 2320 J/msK). In brief, it is desirable that a member having a thermal conductivity of more than 80 J/msK be used as the component of the second casing section 21. A preferable range of the thermal conductivity of the second casing section 21 is not more than 2320 J/msK and more than 80 J/msK for example.

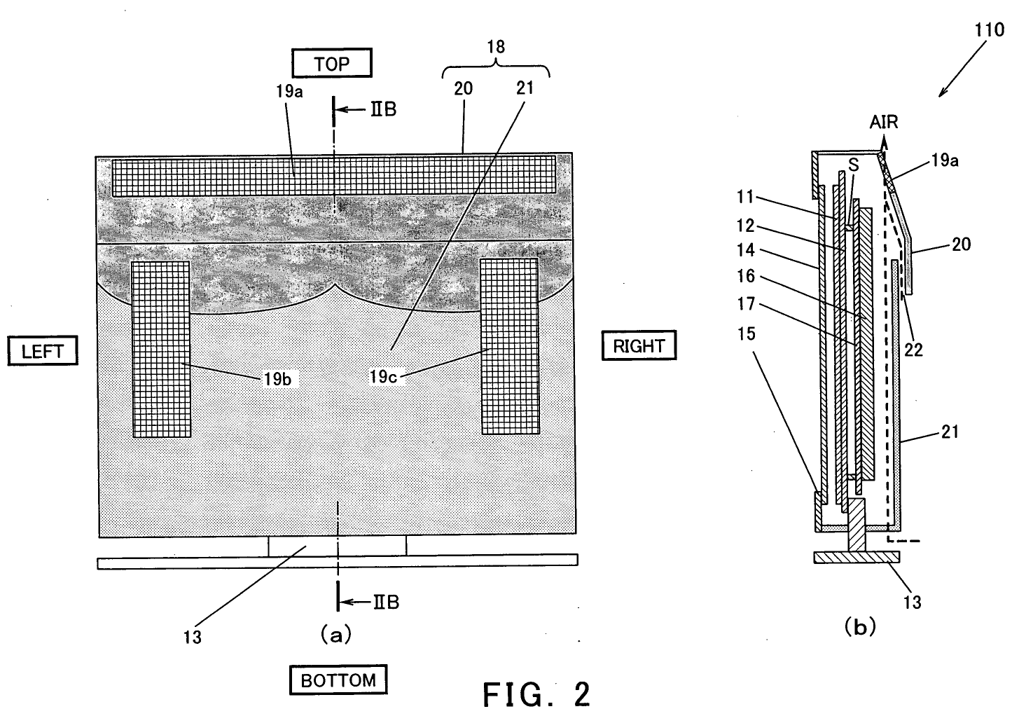

FIG. 2 is an illustration showing another exemplary construction of the plasma display device according to embodiment 1 of the present invention. Specifically, FIG. 2(a) is a rear elevational view showing the plasma display device as viewed from behind and FIG. 2(b) is a sectional view, taken along line IIB-IIB of FIG. 2(a), of the plasma display device.

The construction of the plasma display device 110 shown in FIG. 2 is the same as that of the plasma display device 100 except the feature of a divided portion between the first casing section 20 and the second casing section 21. For this reason, description of features held in common by the two devices will be omitted.

According to FIG. 2, the first casing section 20 comprising a resin material having a relatively low thermal conductivity or the like is spaced by a clearance 22 from and extends upwardly from an upper portion of the second casing section 21 comprising a metal material having a relatively high thermal conductivity. Though not shown, the first casing section 20 is connected to the second casing section 21 at its lateral side portions.

This arrangement allows the clearance 22 as well as the vent hole (not shown) provided at the lower end face of the second casing section 21 to serve as an air intake hole for taking air into the casing 18 thereby allowing smoother ventilation to be achieved.

Thus, air taken into the casing 18 through the vent hole located at the lower end face of the second casing section 21 and through the clearance 22 is warmed within the casing 18 and then exhausted to the exterior of the casing 18 through the vent hole 19a along a path depicted by dotted line in FIG. 2(b) according to the principle of ascending force of air (to be described later).

The casing 18 of each of the plasma display devices 100 and 110 exhibits the following effects and advantages.

Firstly, since the first casing section 20 of the plasma display device 100 is formed from a resin having a relatively low thermal conductivity or the like, the first casing section 20 forming an upper portion of the casing 18, which is likely to be touched by the consumer, is hard to warm. For this reason, the plasma display device 100 does not pose thermally-induced uncomfortable feeling or the like for the consumer.

Though the second casing section 21 of the plasma display device 100 comprises a metal having a relatively high thermal conductivity or the like, the second casing section 21 is located in a lower portion of the plasma display device 100 which is less likely to be touched by the consumer and, hence, the consumer will not be suffered thermally-induced uncomfortable feeling so much for the consumer caused by heat even when the second casing 21 located in the lower portion of the plasma display device 100 is warmed.

Secondly, since the first casing section 20 comprises a resin having a relatively low thermal conductivity or the like, it is difficult for air present in the internal space of the casing 18 to exchange heat with outside air and hence can be heated to elevated temperatures in the upper portion of the casing 18 corresponding to the first casing portion 20. Accordingly, expansion of air thus heated decreases the density of the air and hence causes the ascending force of the air to increase.

Then, air heated to elevated temperatures is exhausted to the outside through the vent hole 19a of the first casing section 20 smoothly. Following the exhaust of air, fresh air is passed into the casing 18 from the outside of the casing 18 through, for example, the vent hole located at the lower end face of the second casing section 21.

Thus, the ascending force of warmed air present within the upper portion of the casing 18 enables air to be effectively exhausted from the inside of the casing 18 to the outside. For this reason, there is no need to provide any exhaust or intake fan additionally, which makes it possible to obviate a noise problem with the plasma display device 100 caused by such a fan as well as to save the cost for the installation of the fan, hence, reduce the cost required for the plasma display device 100 advantageously.

In this way, it is possible to increase the exhaust velocity of air heated in the internal space of the casing 18 without use of any exhaust or intake fan. As a result, the cooling efficiency of the plasma display device 100 can be improved.

With the first casing section 20 comprising a resin having a relatively low thermal conductivity or the like, there is concern that the first casing section 20 plausibly acts as to warm air within the casing 18 thereby impeding the cooling capability of the plasma display device 100 rather than improving the cooling capability.

However, the cooling capability imparted to the plasma display device 100 which is based on effective exhaust of air from the inside of the casing 18 to the outside by the ascending force of warmed air within the upper portion of the casing 18 is superior to the cooling capability based on a uniform heat distribution made by using a material having a relatively high thermal conductivity such as metal.

That is, while the heat dissipation process of a plasma display device involves heat dissipation caused by natural air convection, heat conduction by the casing or the like, and heat radiation by the casing or the like, the inventors of the present invention estimate that such heat dissipation caused by natural air convection is most efficient when the casing has such a rectangular and flat shape as to cover the display section of the flat panel display device. This estimation has been proved by the results of thermo-fluid simulation to be described later.

Thirdly, the second casing section 21 (forming the lower portion of the casing 18) of the plasma display device 100 comprises a metal having a relatively high thermal conductivity or the like and, hence, heat generated within the casing 18 is rapidly transferred to the entire second casing section 21. For this reason, in addition to the heat dissipation effect obtained by the aforementioned air displacement, heat generated within the casing 18 can be dissipated efficiently by heat exchange (heat radiation and heat transfer) with outside air through the second casing section 21.

By using the thermo-fluid simulation technology, the aforementioned heat exhausting effect based on the ascending force of air is verified, while a structural design of the casing 18 of each of the plasma display devices 100 and 110 is made for enhancing the heat exhausting effect to the maximum.

### Analytical Model

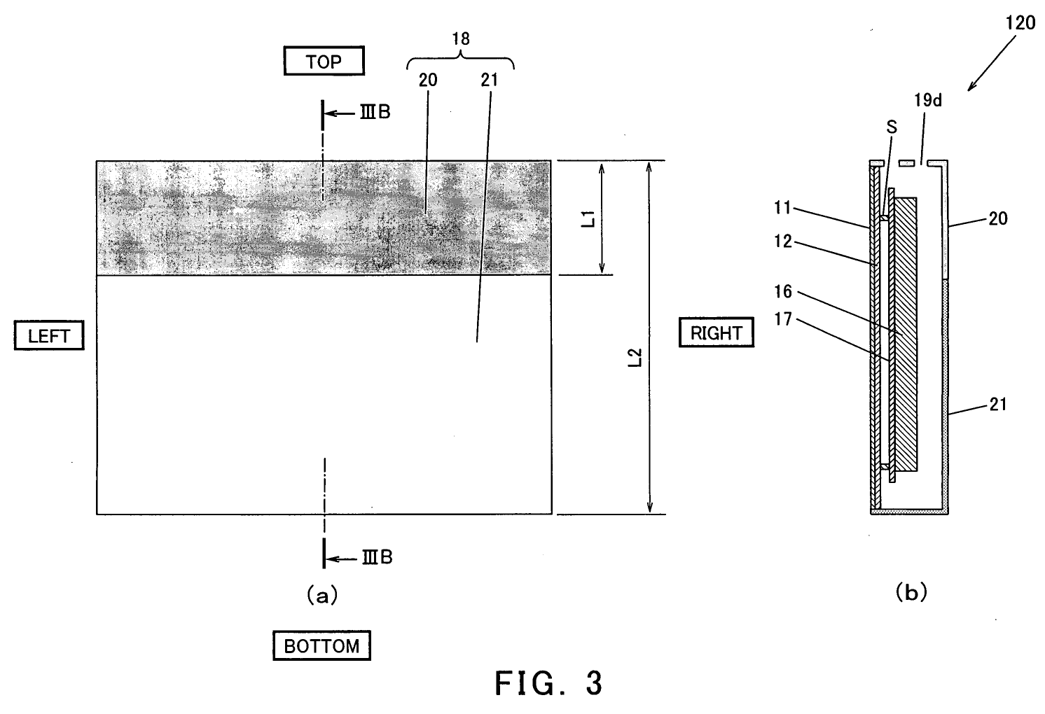

FIG. 3 is an illustration three-dimensionally modeling the plasma display device of FIG. 1 for numerical calculation. Specifically, FIG. 3(a) is a rear elevational view showing an analytical model for the plasma display device as viewed from behind and FIG. 3(b) is a sectional view, taken along line IIIB-IIIB of FIG. 3(a), of the analytical model.

The structure of the analytical model 120 shown in FIG. 3 is more simplified than the actual plasma display device within such limits as not to influence numerical calculation. For example, the analytical model 120 excluding the leg portion 13, front plate 15 and optical filter 14 exerted no influence on the evaluation of numerical analysis. By thus reducing the number of elements corresponding to respective of unit analytical areas for numerical calculation, the storage capacity of a computer used and the calculation time required are saved.

While thermo-fluid simulation is conducted here using the analytical model 120 based on the construction of the plasma display device shown in FIG. 1, a similar analysis result is obtained from thermo-fluid simulation using an analytical model based on the plasma display device 110 shown in FIG. 2.

According to FIG. 3, the substantially rectangular casing 18 having an open front side is divided into the first casing section 20 and the second casing section 21 along a horizontal line at an appropriate vertical position.

Here, a distance L1 measured from the upper end face of the casing 18 is equal to the vertical width of the first casing section 20, and the casing 18 is divided into the first casing section 20 and the second casing section 21 at the position spaced the distance L1 from the upper end face of the casing 18. A distance L2 from the upper end face to the lower end face of the casing 18 is equal to the vertical width of the casing 18.

The substantially rectangular PDP 11 is positioned so as to cover the open side of the casing 18. The substantially rectangular metal support plate 12 holding the PDP 11 is positioned in contact with the rear side of the PDP 11. The circuit board 17 is positioned on the rear side of the metal support plate 12 via the spacer S and carries the electronic component 16 mounted thereon.

The shape of the electronic component 16 in a plan view is modeled into a rectangular shape extending over the entire area of the circuit board 17. (Actually, the electronic component 16 is assumed to comprise a pair of driver LSIs.)

Here, the PDP 11 and electronic component 16 as heat sources are each set to generate an amount of heat under the condition of 200 W. The thermal conductivities of the materials of respective components are inputted and the thermal resistance between adjacent components not taken into consideration.

The material of the first casing section 20 is selected from resins each having a relatively low thermal conductivity or like materials. For example, the material of the first casing section 20 comprises any one selected from a resin comprising polyethylene as a major component (thermal conductivity: 0.25 to 0.34 J/msK), a resin comprising glass fiber as a major component (0.24 to 1.21 J/msK), a resin comprising Bakelite as a major component (0.21 J/msK), a resin comprising epoxy-glass as a major component (0.47 J/msK), and foamed polyurethane (0.02 J/msK).

The material of the second casing section 21 is selected from metals each having a relatively high thermal conductivity or like materials. For example, the material of the second casing section 21 comprises any one selected from aluminum (thermal conductivity: 237 J/msK), iron (80.4 J/msK), copper (401 J/msK), magnesium (156 J/msK), silver (429 J/msK), graphite (1960 J/msK), and diamond (1360 to 2320 J/msK).

As a flow condition of the fluid, natural air convection is assumed to occur throughout elements dividing the space defined by the analytical model, and the air temperature in an element corresponding to an external space of the casing 18 is set to room temperature. An element corresponding to the upper end face of the casing 18 is given an appropriate open area ratio corresponding to the opening 19d and an element corresponding to the lower end face of the casing 18 is also given an appropriate open area ratio (of a non-illustrated opening). Thus, modeling is made so as to allow air ventilation to occur between the inside and the outside of the casing 18.

### Analytical Simulator

Numerical calculation of thermo-fluid in respect of the analytical model 120 shown in FIG. 3 is performed using a general-purpose thermo-fluid analysis program (thermo-fluid analysis software produced by Software Cradle Co., Ltd.; Trademark: STREAM).

A specific analytical technique used is a discretizing technique called “finite volume method”. According to this technique, a region to be analyzed including the analytical model 120 shown in FIG. 3 is discretized into fine spaces each comprised of a hexahedron element (the number of elements: about 30,000). Conventional expressions of relation, which rule heat transfer and flow of fluid on the basis of balance of heat and fluid given and received among these very fine elements, are solved and computation is repeatedly performed until the resulting solutions reach convergence.

The above-mentioned expressions of relation include an equation of motion (Navier-Stokes equation), an equation of energy, and an expression of conservation of an amount of turbulence based on a turbulence model. Detailed description of such expressions will be omitted herein.

### Analysis Result

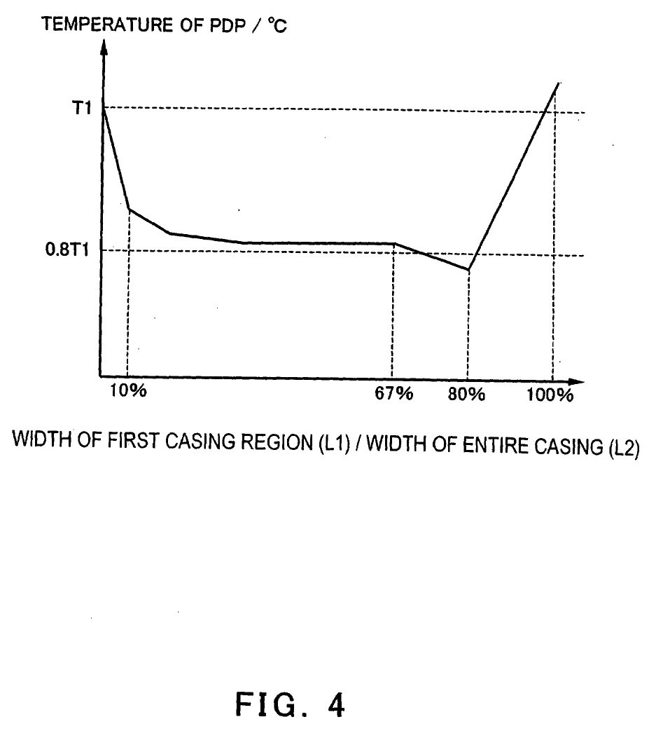

FIGS. 4 to 6 are each a diagram showing one exemplary analysis result obtained by an appropriate processing method based on physical quantity calculation data on each element of the analytical model shown in FIG. 3.

In FIG. 4, the abscissa represents a numerical value (L1/L2) obtained by dividing the vertical width (L1) of the first casing section 20 by the vertical width (L2) of the entire casing 18 and the ordinate represents the temperature (° C.) of the PDP, and the relationship between the two is plotted. Note that the fluorescent material (not shown) coating the inner surface of a partition (not shown) of the PDP 11 is prone to deterioration due to heat and, hence, the necessity of temperature control over the PDP 11 is high.

The “temperature of the PDP 11”, as used herein, is an in-plane average temperature obtained by measurement of temperature at three representative measuring points adjacent each of opposite end faces of the rectangular PDP 11 (six measuring points in total).

Also, the temperature of the PDP 11 is represented as a normalized relative value with respect to a temperature T1 of the PDP 11 obtained when L1/L2=0 (that is, when the entire casing 18 is comprised of the second casing section 21 only having a relatively high thermal conductivity.)

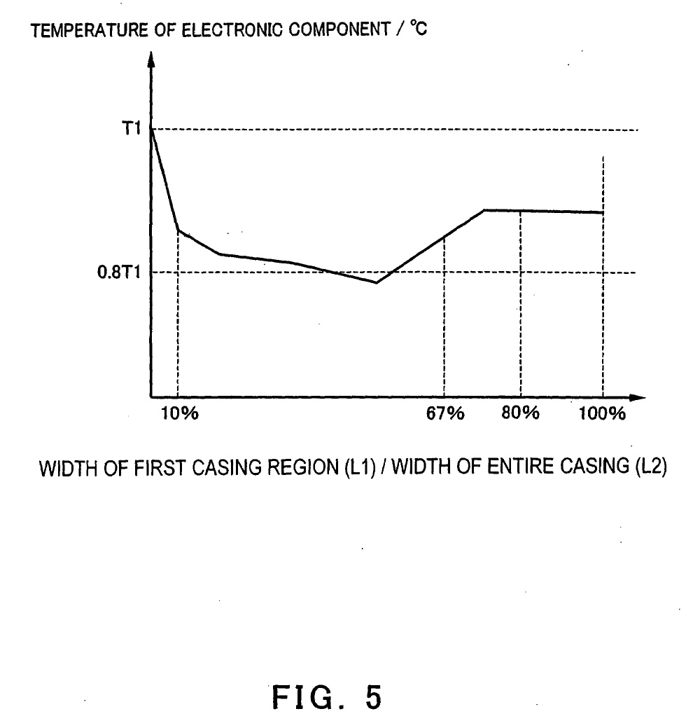

In FIG. 5, the abscissa represents a numerical value (L1/L2) obtained by dividing the vertical width (L1) of the first casing section 20 by the vertical width (L2) of the entire casing 18 and the ordinate represents the temperature (° C.) of the electronic component 16, and the relationship between the two is plotted. Note that a soldered portion of the electronic component 16 has a possibility of causing a contact failure due to heat and, hence, the necessity of temperature control over the electronic component 16 is also high.

The “temperature of the electronic component 16”, as used herein, is an in-plane average temperature obtained by measurement of temperature at three representative measuring points which are located slightly inwardly of the electronic component 16 from the interface between the rectangular electronic component 16 and the circuit board 17 (at a position coinciding with the location of the soldered portion) and adjacent each of opposite end faces of the electronic component 16 (six measuring points in total).

Also, the temperature of the electronic component 16 is represented as a normalized relative value with respect to a temperature T1 of the electronic component 16 obtained when L1/L2=0 (that is, when the entire casing 18 is comprised of the second casing section 21 only having a relatively high thermal conductivity.)

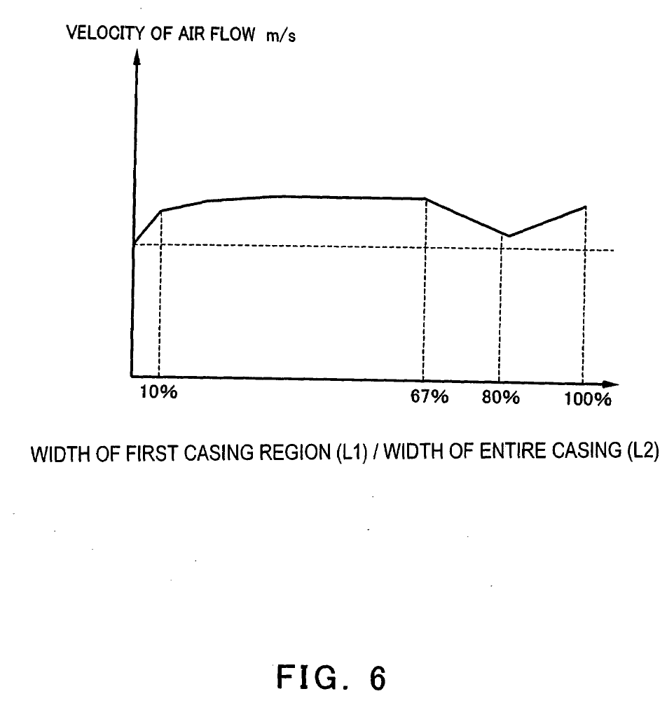

In FIG. 6, the abscissa represents a numerical value (L1/L2) obtained by dividing the vertical width (L1) of the first casing section 20 by the vertical width (L2) of the entire casing 18 and the ordinate represents the velocity (m/s) of air flow at the upper end face of the casing 18, and the relationship between the two is plotted.

The “velocity of air flow”, as used herein, is an average velocity of air flow obtained by measurement at three representative measuring points which are located centrally of the width of the upper end face of the casing 18 along the longitude of the upper end face.

Also, the velocity of air flow is represented as a normalized relative value with respect to a velocity of air flow obtained when L1/L2=0 (that is, when the entire casing 18 is comprised of the second casing section 21 only having a relatively high thermal conductivity.)

According to FIGS. 4 and 5, both of the temperatures of the PDP 11 and the electronic component 16 drop steeply as the ratio of the first casing section 20 having a relatively low thermal conductivity to the entire casing 18 increases from the condition in which L1/L2=0 (i.e., the condition in which the entire casing 18 is comprised of the second casing section 21 only having a relatively high thermal conductivity).

According to FIG. 6, the velocity of air flow increases as the ratio of the first casing section 20 having a relatively low thermal conductivity to the entire casing 18 increases from the condition in which L1/L2=0 (i.e., the condition in which the entire casing 18 is comprised of the second casing section 21 only having a relatively high thermal conductivity).

As can be understood from the results of thermo-fluid simulation thus performed, the first casing section 20 comprising a resin material having a relatively low thermal conductivity or the like in the upper portion of the casing 18 allows displacement of air in the internal space of the casing 18 to take place effectively by the increase in the velocity of air flow caused by the ascending force of warmed air in the internal space of the casing 18, whereby the PDP 11 and the electronic component 16 within the casing 18 are cooled efficiently.

A proper range of L1/L2 is considered to correspond to a domain in which both of the temperatures of the PDP 11 and the electronic component 16 are lowered sufficiently while the velocity of air flow increased certainly. In view of this consideration, it is estimated from FIGS. 4 to 6 that the proper range is more than 1/10 and less than 7/10.

### Embodiment 2

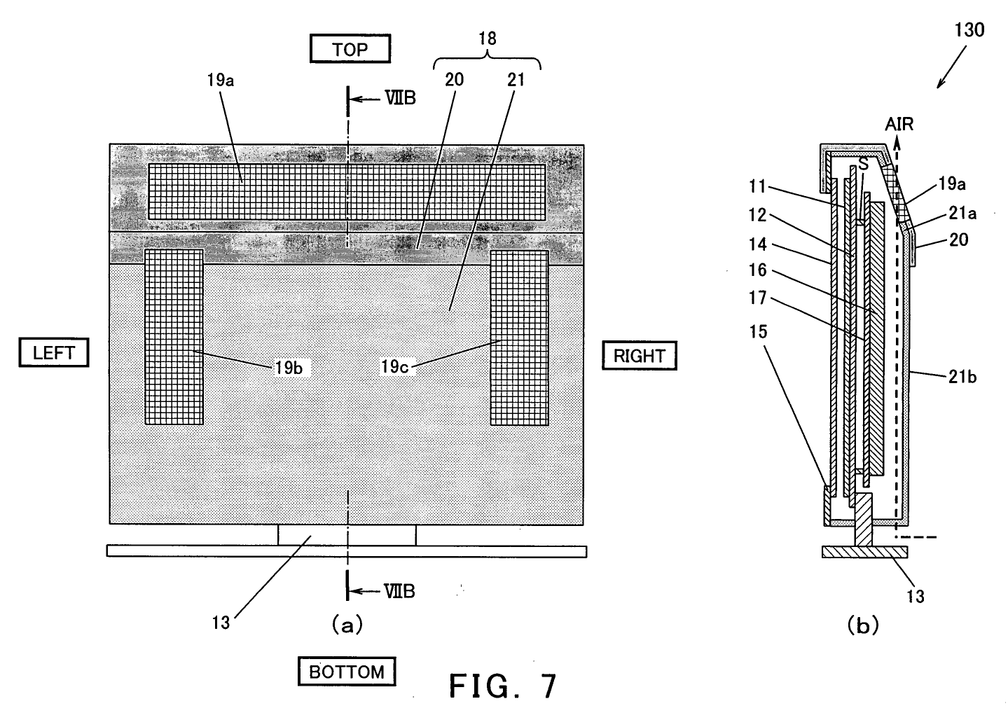

FIG. 7 is an illustration showing one exemplary construction of a plasma display device according to embodiment 2 of the present invention. Specifically, FIG. 7(a) is a rear elevational view showing the plasma display device as viewed from behind and FIG. 7(b) is a sectional view, taken along line VIIB-VIIB of FIG. 7(a), of the plasma display device.

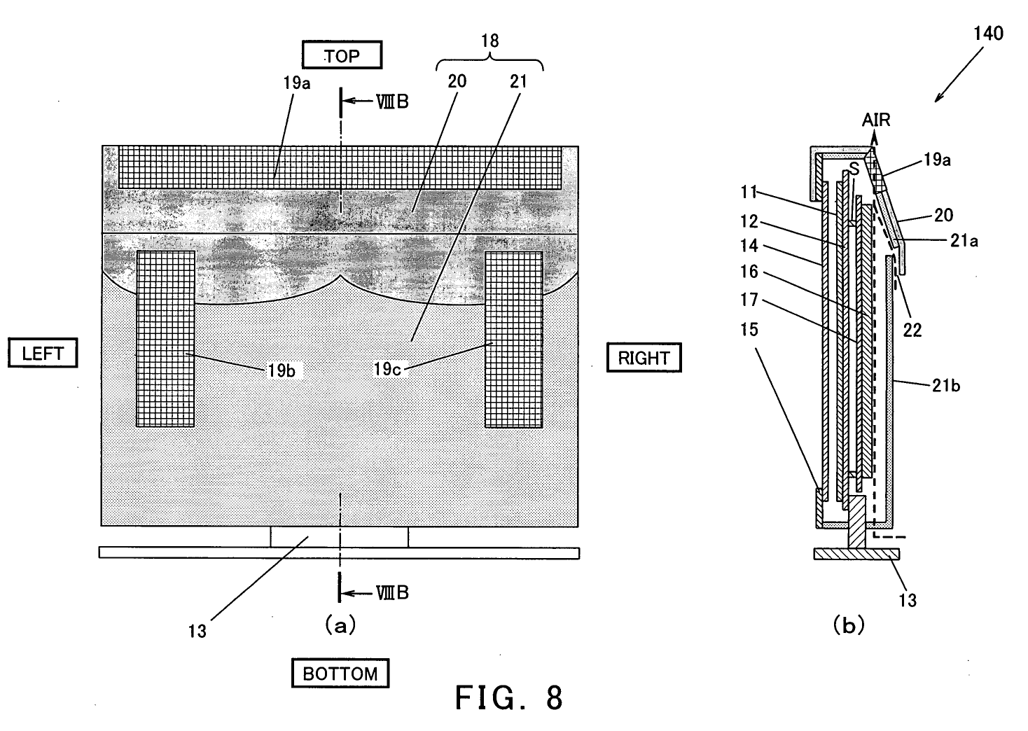

FIG. 8 is an illustration showing another exemplary construction of the plasma display device according to embodiment 2 of the present invention. Specifically, FIG. 8(a) is a rear elevational view showing the plasma display device as viewed from behind and FIG. 8(b) is a sectional view, taken along line VIIIB-VIIIB of FIG. 8(a), of the plasma display device.

The construction of the plasma display device 130 shown in FIG. 7 corresponds to that of the plasma display device 100 shown in FIG. 1. Since the construction of the plasma display device 130 is the same as that of the plasma display device 100 except that a first casing section 20,21a has a layered structure in which a resin layer 20 (cover portion) is superposed on the outer surface of an extended portion 21a comprising the same material as the second casing section 21b, description of features shared by the two will be omitted.

Similarly, the construction of the plasma display device 140 shown in FIG. 8 corresponds to that of the plasma display device 110 shown in FIG. 2. Since the construction of the plasma display device 140 is the same as that of the plasma display device 110 except that the first casing section 20,21a has a layered structure in which the resin layer 20 (cover portion) is superposed on the outer surface of a separated portion 21a comprising the same material as the second casing section 21b, description of features shared by the two will be omitted.

According to FIG. 7, the casing 18 comprises plural materials that are different in thermal conductivity from each other. In one example, the casing 18 has a lower portion forming the second casing section 21b comprising a metal material having a relatively high thermal conductivity or the like.

The first casing section 20,21a, which is partially comprised of a resin material having a relatively low thermal conductivity or the like, has the resin layer 20 having a relatively low thermal conductivity which is superposed on the outer surface of the extended portion 21a to form a layered structure, the extended portion 21a extending continuously with the second casing section 21b and comprising the same material as the second casing section 21b. The resin layer 20 extends upwardly while being in contact with the outer surface of the extended portion 21a.

The resin layer 20 and the extended layer 21a are joined with each other by appropriate fastening means such as adhesive.

In this embodiment, the first casing section 20,21a (in an upper portion of the plasma display device 130) having the layered structure comprising the resin layer 20 and the extended portion 21a is provided with the substantially rectangular vent hole 19a extending in the horizontal direction of the plasma display device 130 as an air exhaust hole in the form of mesh for exhausting air from the inside of the casing 18. The second casing section 21b has a lower end face provided with an appropriate vent hole (not shown) as an air intake hole for taking air into the casing 18.

Thus, air taken into the casing 18 through the vent hole located at the lower end face of the second casing section 21b is warmed within the casing 18 and then exhausted to the exterior of the casing 18 through the vent hole 19a along a path depicted by dotted line in FIG. 7(b) according to the principle of ascending force of air described in Embodiment 1.

As in the construction shown in FIG. 7, the casing 18 shown in FIG. 8 has a lower portion forming the second casing section 21b comprising a metal material having a relatively high thermal conductivity or the like.

The first casing section 20,21a, which is partially comprised of a resin material having a relatively low thermal conductivity or the like, has the resin layer 20 having a relatively low thermal conductivity which is superposed on the outer surface of the separated portion 21a to form a layered structure, the separated portion 21a being spaced by the clearance 22 from the second casing section 21b and comprising the same material as the second casing section 21b. Like the separated portion 21a, the resin layer 20 is spaced by the clearance 22 from the second casing section 21b and extends upwardly while being in contact with the outer surface of the separated portion 21a.

This arrangement allows the clearance 22 as well as the vent hole (not shown) provided at the lower end face of the second casing section 21 to serve as an air intake hole for taking air into the casing 18 thereby allowing smoother ventilation to be achieved. The first casing section 20,21a shown in FIG. 8 is also provided with the vent hole 19a as in FIG. 7.

Thus, air taken into the casing 18 through the vent hole located at the lower end face of the second casing section 21 and through the clearance 22 is warmed within the casing 18 and then exhausted to the exterior of the casing 18 through the vent hole 19a along a path depicted by dotted line in FIG. 8(b) according to the principle of ascending force of air described in Embodiment 1.

Examples of materials for the resin layer 20 include a resin comprising polyethylene as a major component (thermal conductivity: 0.25 to 0.34 J/msK), a resin comprising glass fiber as a major component (0.24 to 1.21 J/msK), a resin comprising Bakelite as a major component (0.21 J/msK), a resin comprising epoxy-glass as a major component (0.47 J/msK), and foamed polyurethane (0.02 J/msK). In brief, it is desirable that a member having a thermal conductivity of less than 1.5 J/msK be used as the component of the resin layer 20. A preferable range of the thermal conductivity of the resin layer 20 is not less than 0.02 J/msK and less than 1.5 J/msK for example.

Examples of materials for the second casing section 21b include aluminum (thermal conductivity: 237 J/msK), iron (80.4 J/msK), copper (401 J/msK), magnesium (156 J/msK), silver (429 J/msK), graphite (1960 J/msK), and diamond (1360 to 2320 J/msK). In brief, it is desirable that a member having a thermal conductivity of more than 80 J/msK be used as the component of the second casing section 21b. A preferable range of the thermal conductivity of the second casing section 21b is not more than 2320 J/msK and more than 80 J/msK for example.

While the second casing section 21b and the extended portion 21a are formed from the same metal plate in this embodiment, it is needless to say that the two may be formed from respective of different materials. Similarly, while the second casing section 21b and the separated portion 21a are formed from the same metal plate in this embodiment, it is needless to say that the two may be formed from respective of different materials.

By the resin layer 20 having a relatively low thermal conductivity on the upper outer surface of the casing 18 of each of the plasma display devices 130 and 140, the plasma display devices 130 and 140 each exhibit effects and advantages same as those exhibited by each of the plasma display devices 100 and 110 described in Embodiment 1.

As in Embodiment 1, by using the thermo-fluid simulation technology, the aforementioned heat exhausting effect based on the ascending force of air is verified, while a structural design of the casing 18 of each of the plasma display devices 130 and 140 is made for enhancing the heat exhausting effect to the maximum.

### Analytical Model

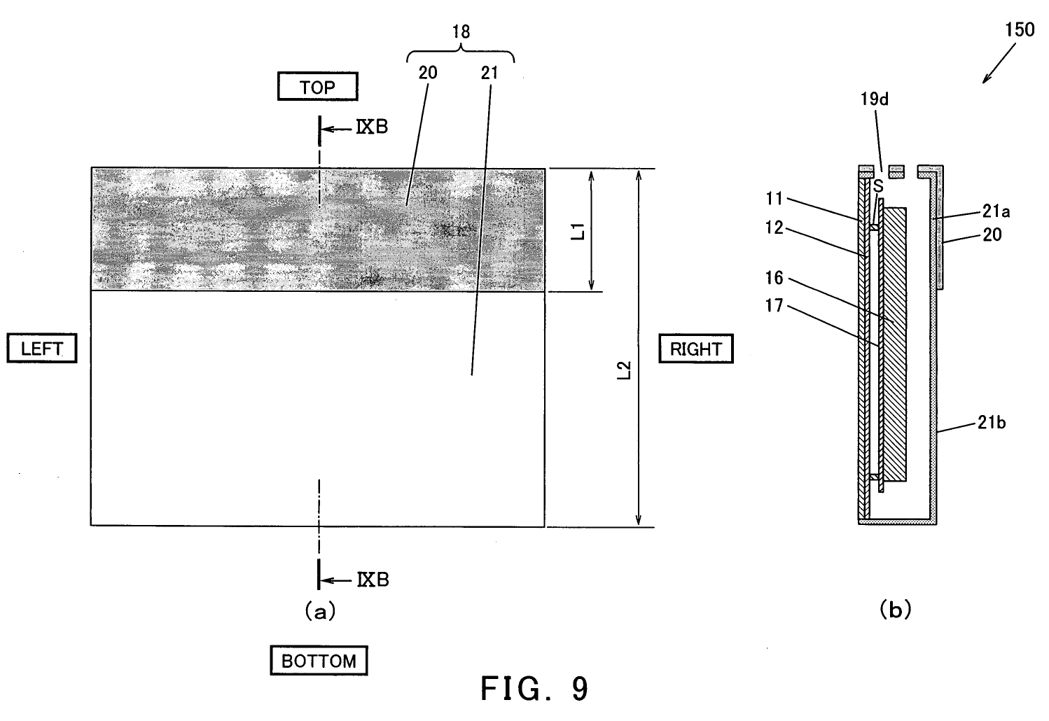

FIG. 9 is an illustration three-dimensionally modeling the plasma display device of FIG. 7 for numerical calculation. Specifically, FIG. 9(a) is a rear elevational view showing an analytical model for the plasma display device as viewed from behind and FIG. 9(b) is a sectional view, taken along line IXB-IXB of FIG. 9(a), of the analytical model.

The structure of the analytical model 150 shown in FIG. 9 corresponds to that of the analytical model 120 (FIG. 3) for the plasma display device described in Embodiment 1. The analytical model 150 is based on the modeling concept underlying the analytical model 120 except that the first casing section 20,21a has a layered structure in which the resin layer 20 (cover portion) is superposed on the outer surface of the extended portion 21a comprising the same material as the second casing section 21b. For this reason, features shared by the two will be omitted.

While thermo-fluid simulation is conducted here using the analytical model 150 based on the construction of the plasma display device shown in FIG. 7, a similar analysis result is obtained from thermo-fluid simulation using an analytical model based on the plasma display device 140 shown in FIG. 8.

According to FIG. 9, the casing 18 having an open front side comprises the first casing section 20,21a and the second casing section 21b which draw a boundary therebetween at an appropriate vertical position. The first casing section 20,21a, which is partially comprised of a resin material having a relatively low thermal conductivity or the like, has the resin layer 20 having a relatively low thermal conductivity which has an L-shape in section and is superposed on the outer surface of the extended portion 21a to form the layered structure, the extended portion 21a being continuous with the second casing section 21b and comprising the same material as the second casing section 21b.

Here, the distance L1 measured from the upper end face of the casing 18 is equal to the vertical width of the first casing section 20,21a and the resin layer 20 covers the outer surface of the extended portion 21a over the distance L1 from the upper end face of the casing 18 to form the layered structure. The distance L2 from the upper end face to the lower end face of the casing 18 is equal to the vertical width of the casing 18.

### Analytical Simulator

As in Embodiment 1, numerical analysis is performed using the general-purpose analysis software named STREAM (trademark).

### Analysis Result

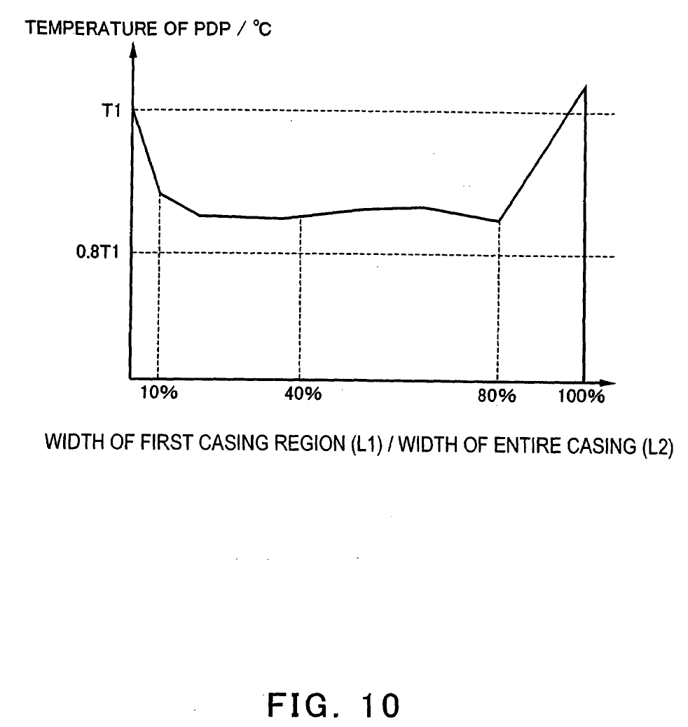

FIGS. 10 to 12 are each a diagram showing one exemplary analysis result obtained by an appropriate processing method based on physical quantity calculation data on each element of the analytical model shown in FIG. 9.

In FIG. 10, the abscissa represents a numerical value (L1/L2) obtained by dividing the vertical width (L1) of the first casing section 20,21a by the vertical width (L2) of the entire casing 18 and the ordinate represents the temperature (° C.) of the PDP, and the relationship between the two is plotted.

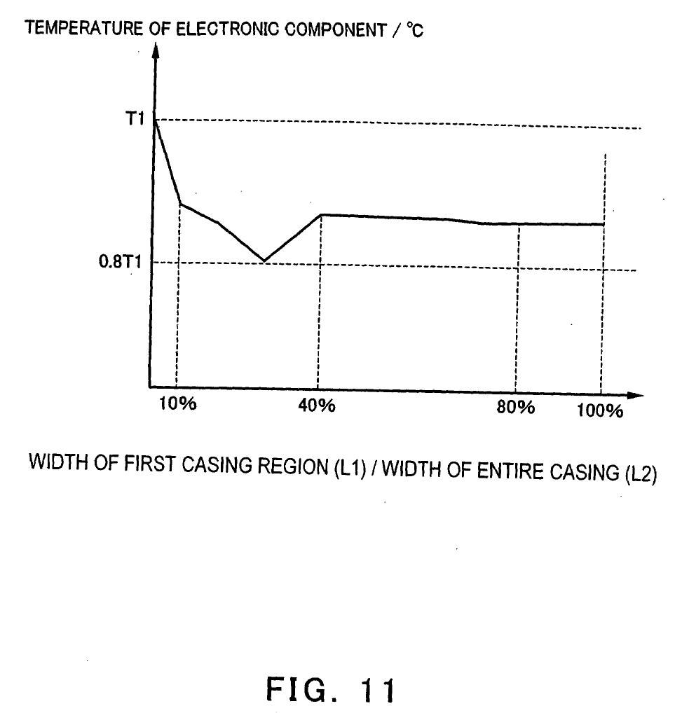

In FIG. 11, the abscissa represents a numerical value (L1/L2) obtained by dividing the vertical width (L1) of the first casing section 20,21a by the vertical width (L2) of the entire casing 18 and the ordinate represents the temperature (° C.) of the electronic component, and the relationship between the two is plotted.

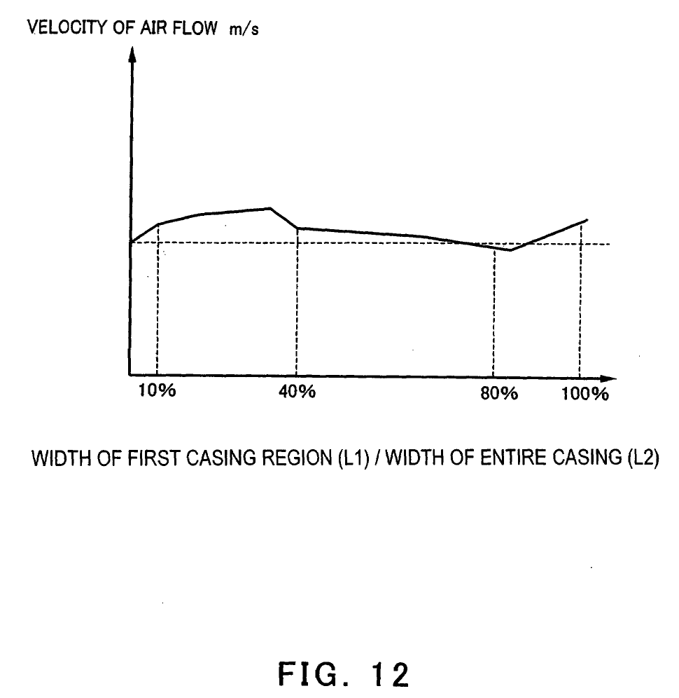

In FIG. 12, the abscissa represents a numerical value (L1/L2) obtained by dividing the vertical width (L1) of the first casing section 20,21a by the vertical width (L2) of the entire casing 18 and the ordinate represents the velocity (m/s) of air flow at the upper end face of the casing 18, and the relationship between the two is plotted.

The definitions of respective of the “temperature of the PDP”, the “temperature of the electronic component” and the “velocity of air flow” are the same as those noted in Embodiment 1.

According to FIGS. 10 and 11, both of the temperatures of the PDP 11 and the electronic component 16 drop steeply as the ratio of the first casing section 20,21a having a relatively low thermal conductivity to the entire casing 18 increases from the condition in which L1/L2=0 (i.e., the condition in which the entire casing 18 is comprised of the second casing section 21b only having a relatively high thermal conductivity).

According to FIG. 12, the velocity of air flow increases as the ratio of the first casing section 20,21a having a relatively low thermal conductivity to the entire casing 18 increases from the condition in which L1/L2=0 (i.e., the condition in which the entire casing 18 is comprised of the second casing section 21b only having a relatively high thermal conductivity).

As can be understood from the results of thermo-fluid simulation thus performed, by providing the resin layer 20 comprising a resin material having a relatively low thermal conductivity or the like in the upper portion of the casing 18 in such a manner as to cover the extended portion 21a of the second casing section 21b, displacement of air in the internal space of the casing 18 took place effectively by the increase in the velocity of air flow caused by the ascending force of warmed air in the internal space of the casing 18, whereby the PDP 11 and the electronic component 16 within the casing 18 are cooled efficiently.

A proper range of L1/L2 is considered to correspond to a domain in which both of the temperatures of the PDP 11 and the electronic component 16 are lowered sufficiently while the velocity of air flow increased certainly. In view of this consideration, it is estimated from FIGS. 10 to 12 that the proper range is more than 1/10 and less than 4/10.

While the efficient heat dissipation technique applied to the plasma display device as an example of the flat panel display device has been described above, the heat dissipation technique described above may be applied not only to such a plasma display device but also to any flat panel display device which has a rectangular and flat casing and a heat-generating member located in the internal space of the casing.

For example, the heat dissipation technique is considered to be useful for liquid crystal display devices generally having a rod-shaped backlight source as a heat-generating member within the casing.

The heat dissipation technique is also applicable to FED (Field Emission Display) devices and organic EL display devices because a FED and an organic EL panel generate heat.

It will be apparent from the foregoing description that many improvements and other embodiments of the present invention may occur to those skilled in the art. Therefore, the foregoing description should be construed as an illustration only and is provided for the purpose of teaching the best mode for carrying out the present invention to those skilled in the art. The details of the structure and/or the function of the present invention can be modified substantially without departing from the spirit of the present invention.

### INDUSTRIAL APPLICABILITY

The flat panel display device according to the present invention is capable of reliably inhibiting the surface temperature of a relevant portion of the casing of the flat panel display device from rising too much while efficiently cooling the inside of the casing and is useful as a thin-screen television for home use for example.

1-14. (canceled)

15. A flat panel display device comprising:
a flat display panel;
a front cover having an opening matching a display surface of said flat display panel; and
a casing having first and second casing sections and covering a rear side of said flat display panel,
said first casing section having a lower thermal conductivity than said second casing section, extending upwardly from said second casing section, and being provided with a vent hole.

16. The flat panel display device according to claim 15, wherein said first casing section is in contact with an end portion of said second casing section.

17. The flat panel display device according to claim 15, wherein said first casing section and said second casing section define a clearance therebetween.

18. The flat panel display device according to claim 16, wherein said first casing section is formed from a material comprising resin, while said second casing section formed from a material comprising metal.

19. The flat panel display device according to claim 17, wherein said first casing section is formed from a material comprising resin, while said second casing section is formed from a material comprising metal.

20. The flat panel display device according to claim 16, wherein said first casing section has a thermal conductivity of not less than 0.02 J/msK and less than 1.5 J/msK, while said second casing section has a thermal conductivity of not more than 2320 J/msK and more than 80 J/msK.

21. The flat panel display device according to claim 17, wherein said first casing section has a thermal conductivity of not less than 0.02 J/msK and less than 1.5 J/msK, while said second casing section has a thermal conductivity of not more than 2320 J/msK and more than 80 J/msK.

22. The flat panel display device according to claim 16, wherein a value obtained by dividing a vertical width of said first casing section by a vertical width of said casing is more than 1/10 and less than 7/10.

23. The flat panel display device according to claim 17, wherein a value obtained by dividing a vertical width of said first casing section by a vertical width of said casing is more than 1/10 and less than 7/10.

24. The flat panel display device according to claim 15, wherein said first casing section has an extended portion extending continuously with said second casing section and comprising the same material as said second casing section, and a cover portion layered to cover an outer surface of said extended portion, said cover portion extending upwardly while being in contact with the outer surface of said extended portion.

25. The flat panel display device according to claim 15, wherein said first casing section has a separated portion spaced by a clearance from said second casing section and comprising the same material as said second casing section, and a cover portion layered to cover an outer surface of said separated portion, said cover portion extending upwardly while being in contact with the outer surface of said separated portion.

26. The flat panel display device according to claim 24, wherein said cover portion is formed from a material comprising resin, while said second casing section is formed from a material comprising metal.

27. The flat panel display device according to claim 25, wherein said cover portion is formed from a material comprising resin, while said second casing section is formed from a material comprising metal.

28. The flat panel display device according to claim 24, wherein said cover portion has a thermal conductivity of not less than 0.02 J/msK and less than 1.5 J/msK, while said second casing section has a thermal conductivity of not more than 2320 J/msK and more than 80 J/msK.

29. The flat panel display device according to claim 25, wherein said cover portion has a thermal conductivity of not less than 0.02 J/msK and less than 1.5 J/msK, while said second casing section has a thermal conductivity of not more than 2320 J/msK and more than 80 J/msK.

30. The flat panel display device according to claim 24, wherein a value obtained by dividing a vertical width of said first casing section by a vertical width of said casing is more than 1/10 and less than 4/10.

31. The flat panel display device according to claim 25, wherein a value obtained by dividing a vertical width of said first casing section by a vertical width of said casing is more than 1/10 and less than 4/10.

32. The flat panel display device according to claim 15, which has a function of exhausting air through the vent hole.

33. The flat panel display device according to claim 17, which has a function of taking in air through the clearance.

34. The flat panel display device according to claim 15, wherein said flat display panel is a plasma display panel.
